(19) United States
(12) Patent Application Publication
(10) Pub. No.: US 2022/0015548 A1
(43) Pub. Date: Jan. 20, 2022

(54) BED LIFTING SYSTEM

(71) Applicant: Adán Javier ELIZONDO QUINTANNILI, Nuevo León 6626 (MX)

(72) Inventor: Adán Javier ELIZONDO QUINTANILLA, Mexico City (MX)

(21) Appl. No.: 17/311,321

(22) PCT Filed: Nov. 21, 2019
(86) PCT No.: PCT/MX2019/000125

§ 371 Date: Jun. 5, 2021

(30) Foreign Application Priority Data
Dec. 18, 2018 (MX) MX/A/2018/015970

(51) Int. Cl. A47C 19/04

(52) U.S. Cl. CPC A47C 19/045

(57) ABSTRACT

lifting system for beds of the type that is placed under the bed to lift and separate the bed from the wall to an elevated position to make the bed without crouching or being in bad position and making accessible the space below the bed; it consists of a frame with at least one set of rotating lifting legs in the form of “H” supported directly to the floor, joined together by equalizer arms forming a parallelogram near half of the lifting legs, forcing the turn that make one pair of legs the other in the same way, achieving that the frame is always maintained horizontally during its displacement, derived from the rotary movement of the pairs of lifting legs; Said frame with holes where to scramble and hold extensions, has a bolt and a latch that allows the frame to remain in its rest position on its own integrated supports to the legs and also has a lifting system that rotates on a bolt of rotation that crosses the extension of the lifting leg in “H” shape, the strength transmission arm and the semi-pulley and which also consists of at least one elastic means link to the force regulating arm to supplement the necessary force and achieve the harmonic movement of displacement either lifting or vice versa of the frame, which supports the base of the bed.

### FIELD OF THE INVENTION

The present invention relates to a bed elevation system in general, is related to a lifting structure for beds that is placed under the bed, with the intention of lifting and separating the bed from the wall and the night tables, at a rafted position to make the bed without crouching over the bed, or being in bad position and making the lower space of the bed accessible for cleaning and more specifically it is referred to a metallic frame that by means of a pulley-based mechanism. Tensioners, elastic media and straight arms facilitates the lifting of the bed.

### BACKGROUND OF THE INVENTION

Arises from the need to tend sheets and blankets from the beds in an inconvenient position, because the standard height of the beds, are lower than the height of the waist of most users, which in the long run It can cause for users of beds or ailments of back, neck. arms.

Generally users at bedtime we sat on the bed and lay on bed, and when we get up, we first sat on the bed and we got up after, leaving the surface the bed in an inconvenient position for those who tend the bed since it has to duck and lean over the bed and work their hands under their waist to tend the sheets and blankets, besides that the night tables impede the reach of parts near the backrest or wall against which the bed is usually accommodated.

Attached to the above, the beds that coincide with one or more walls or other surface may be more difficult to perform, as well as the fact that the cleaning under the bed is commonly done deficiently and in a superficial way because of the difficulty to get access to the space under the bed.

Such problems become more acute in hospitals or in a commercial context such as hotels and similar, where many beds should be done in a short period of time, often causing back injuries to workers who perform these tasks. The injuries to workers have caused a significant loss of quality of life and productivity and in addition to greater medical expenses insurance for employers.

At present, some commercial models of bedresting platforms have been presented; All of them formed properly to enable work in a comfortable position, as well as make accessible the lower space of said bed and in some cases also allow to separate the bed from the walls or other surfaces.

The bed lifting system is placed under the bed with the intention of lifting and separating the bed from the wall and the bedside tables, to a raised position to tend without crouching over the bed or be in bad position.

At present, the low diffusion of this type of platforms has been found because in its entirety they use a tubular frame that rests on the floor from which the rotating legs are attached, which prevents direct access to the floor, also in some cases they use an electromechanic lifting system, which is expensive and presents the risk of fire, and in the vast majority of cases they use directly elastic means to the arms preventing the possibility of regulating the strength of the elastic media, the load capacity range of the platforms is quite limited, as well as the capacity of the system to function with a large portion of the market.

In order to solve the aforementioned problem, that is to set a mechanical lifting system without a fire risk, which is suitable for service a large load range only by adjusting the support of the elastic media, as well as adaptable for any of the beds existing in the market, the current model of lifting system for beds is presented.

With the bed lifting system, the making of the bed, the effort becomes easier and without risks of back injuries, waist, shoulders, arms and neck. In addition, this model of lifting system for beds does not risk the integrity of the, furniture, buildings and occupants, since it does not have electromechanical mechanisms or electrical regulators that can be heated and burnt. Helping thus not to increase insurance premises by accident or fire.

This lifting system model is constructed with metallic materials, using as a source of energy for its movement, elastic means so there is no risk of fire or burns. In addition to having the ability to graduate the required force according to the weight to be displaced.

At present there are several types of beds ranging from small to large through a range of weights that can be light or heavy. But in reality very few people or institutions know for sure what is the real weigh of their mattress and their bed in total, which had made it difficult to present a single model of elevator system for beds with capacity to raise the various models of beds, for that reason we went to the task of designing a model that can be adapted to the majority of the sizes of beds, and the weigth of the beds.

The present model lifting system has a size that covers single beds and with the use of extensions can cover the beds known as double or king-size, in reference of the weight of the bed, this model of lifting system for beds has the possibility of graduating the force that delivers the elastic means and in this way the user without knowing the weight of their bed can easily adjust the required force in particular to raise the bed to the work position. The force regulator mechanism is designed so that once the force of the mechanism is adjusted, the only work that is required is to drive the lock to release the lifting mechanism when it is required to lift the bed, and gently push the bed down and forward when it requires lowering the bed, and the rising system mechanism for beds will do the rest of the effort so that in the elevated position the user will work standing up straight without having to bend over the bed to make the bed, once the making of the bed is done in an upright posture, the bed is easily returned to the rest position,

A search was performed to define the nearest technique: As corresponding to the present invention, Patent MX 202768 was found, by means of presentation of Sep. 20, 1984, “bed improvements with articulated frame, for example for hospitals,” on the basis of Industries Lux Conti, S.A. Of c.v.; which discloses bed improvements with an articulated frame comprising a support base for a lifting and descending welded grid, which usually consists of three pieces, a spinal, a central and the other support for the lower limbs, said base being provided with wheels for the displacement of the bed, characterized in that it carries at least one set of joystick that acts on a blocking system in various positions consisting of an extensible arm, equipped with an elastic tension system and in which One end of the arm acts on a lever connected to a throttle section of the tree connection to a fixed central grid section that supports an orientation device for rotating the corresponding grid terminal end connected to the aforementioned orientation device.

The patent EP 1281659 was also found, with a submission date of Aug. 3, 2001, “Scissor Lift with Retractable Wheels”, based on Bolzoni Spa; Which discloses a pantograph lifting platform comprising a base designed to rest on the ground during its use and from which a kinematic pantograph mechanism is raised, mechanism that can be operated to lift a flat loading platform from the base. The platform comprises wheel sets that are susceptible to coupling in the kinematic mechanism to impulsively lift the base of the soil when the loading platform moves with respect to the base, thus allowing its displacement.

Likewise, the AU 199897236 application was found, by means of a submission date on December 30, 1997, “Lifting Device”, as Murray Graeme Schofield; which discloses a lifting device having a lower frame, a higher frame, at least one articulated device connecting the lower frame to the upper rack to retain the upper frame and the lower frame in alignment during the rise and downstream of the upper frame with Regarding the lower frame, at least one lifting means attached to the upper frame and the lower frame to allow the upper frame to rise with respect to the lower rack without external assistance, and retaining means in one of the upper and lower frames adapted for Maintain the upper frame and the bottom rack closely before the upper frame lifting.

Preferably, the means for raising the upper frame is a hydraulic or pneumatic piston. More preferably, the lifting means also include a second hydraulic or pneumatic piston. Advantageously, the second piston is connected at its upper end to the upper rack and is free at its lower end. More advantageously, the second piston is arranged'substantially vertically.

We also found U.S. Pat. No. 7,767,313, with date of Jul. 20, 2003. “Bed Lifting System”, as Jhon Koorey; Which discloses “a bed lifting system to lift a bed comprising a lower frame and a top frame and a bed lifting mechanism and a remotely located switch from the bed lifting mechanism. The switch is adapted to allow selective and remote activation of the bed lifting mechanism. The mechanism can be provided in the form of a kit by using the table connectors that can also improve the interconnection and interoperability of the mechanism frame elements. The mechanism may also comprise adjustable parts to accommodate variable bed types”.

Likewise, the following documents related to the present invention were found: U.S. Pat. Nos. 8,739,329, 7,941,879, 3,887,950, PCT/US1999/029390, MX/A/2015/017393, FR2798053, FR2674415, AU199897236, NL9401725.

As is evident, the aforementioned documents present novelties concerning platform modalities for bed elevation other than the present invention, of the above documents, none presented an invention that resolves the problem of bed elevation through a structure that has a group of pivoting rigid legs to the structure, that said legs make contact at the opposite end of the pivoting directly to the floor without intervention of a lower tubular frame, and by elastic means, semi pulleys and straight arms separate the set of straight legs (or curves) Of the structure to which they are crimped, and that consequently the structure is separated from the ground by carrying with it the burden on it.

Likewise, the present invention comprises a lifting system consisting of an adjustable force transmission arm that allows to exert a great force at the start of the lifting and decrease the same to reach the end point of the cycle with little force, in addition to having A force regulating system that makes it possible to graduate the force that delivers the elastic means depending on the weight of the bed and thanks to the combination of the two systems works for a large part of the market It can thus be able to lift beds from a range of 30 to 170 and more kilograms with only with small adjustments in the props of the elastic media.

The design of the lifting mechanism of this bed lifting system model causes the height change path through which the frame passes by loading the bed from the rest position to work and vice versa is harmonious as it has a harmonic Strength graduator according to the position in which it is during the cycle

This model of lifting platform for beds has a design that has an advantage that in all positions that are between the work position and rest, the force that is needed is graduated by the mechanism.

Once the bed is stretched, the user push down the bed applying a little additional force to overcome the balance between force and weight, by pushing it down, energy accumulates in the elastic media for the next cycle.

This model of lifting system has a design that has an advantage in which only the end of the pivoting legs makes contact with the floor. facilitating the cleaning of the surface where the bed is unlike the existing models that count With a tubular frame that rests on the floor and from which they rest and engage the lifting legs.

This bed lifting system model has a suitable design to maintain at any point the frame and its resting load, together with the above it is possible to graduate it with a little more of the force necessary so that the user does not make any effort to carry The platform of the rest position to work.

Unlike those existing in the market, when the elastic means of the present invention lose their ability to store energy, it would only be necessary to make a small adjustment in the support of the elastic media to compensate for said capacity to store energy. Some existing models require electricity and electromagnetic controls, voltage regulators and electric motors which present the risk of overheating or fire; This model of lifting platform for beds does not risk the integrity of the, furniture, buildings and occupants since it has no electromechanical mechanisms or electrical regulators that can be heated, generate toxic gases and burn.

This model lifting system has a design that has an additional advantage that rigid legs can be curved or partially curved, which facilitates startup since being supported the curved legs, variates the distance from the support against the floor and in this way a lower effort of the elastic media is required.

### OBJECTIVES OF THE INVENTION

The main objective is to make available a bed lifting system available to solve the drawbacks presented by the models prior to the present invention.

Another object of the present invention is that said bed lifting system supports an extensive range of weights and bed dimensions.

Another object of the present invention is that said bed lifting system is suitable for the vast majority of existing beds in the market, from single to doublebed called King Size.

Even another objective of the present invention is that said bed elevation system only uses elastic means as a source of energy for movement.

Another object of the present invention is to allow said bed elevation system to not risk the integrity of, furniture, buildings and occupants since it does not have electromechanical mechanisms or electrical regulators that can heat generate toxic gases and catch fire.

Even another objective of the present invention is that said bed elevation system only uses elastic means as a source of energy for movement, requiring a more economical insurance premium for buildings where it is used.

Still another object of the present invention is to allow said bed elevation system once the elastic medium decreases its strength, there is no need to replase it, since it only requires the elastic media to the next position of the regulatory arm of force.

Another object of the present invention is to allow said lifting system for beds to be in the working position, only make contact with the ground the ends of the legs leaving without obstacles to make the cleaning at depth of the floor under the bed,

Another object of the invention is to allow that bed lifting system the making of the bed work of the bed becomes easier and without risks of back injuries, waist, shoulders, arms and neck.

Another object of the present invention is to allow such bed lifting system to graduate the ability to store energy from elastic means in order to achieve the force required in the mechanism as the weight to be displaced.

Another object of the present invention is to allow such bed lifting system to help improve the quality of life and productivity of users.

Even another object of the invention is to allow said bed lifting. system the only work that is required is to gently push your bed down and forward so that the elastic media from the lifting pia for beds are activated

Still another object of the invention is to allow said bed lifting system once the bed is easily lowered by the bed by applying a bit of additional force to overcome the balance between force and weight.

Still another object of the invention is to make it available that said bed lifting system by pushing it downwards accumulates energy in the elastic media for the next cycle.

Another object of the present invention is to allow said bed lifting system to have a force regulator that allows it to be harmonic the travel change and displacement through which the platform passes from the bed from the rest position to the of work and vice versa.

Another object of the present invention is to allow that bed lifting system to graduate the force needed in each of the positions between the working position and the rest

Even another object of the invention is that said bed lifting system can be graduated with a little more force necessary for the user to make no effort when carrying the platform of the rest position to work position.

Another object of the invention is to allow said bed lifting system to keep the resting position when the bolt crimps with the latch

Even another objective of the invention is that said bed lifting system does not require electricity and electromagnetic controls.

Another object of the invention is that such bed lifting system does not require having electric motors or electric voltage regulators below or near the bed

Even another objective of the present invention is to allow said bed lifting system to present a long life of the elastic means with which the bed lifting work is performed.

Also an objective more of the present invention is to allow said bed lifting system to provide a type structure for bed lift in a simplified and low-cost design.

Even another objective of the present invention is to allow said bed lifting system to maintain the structure in working position by means of a clamping mechanism.

And all those qualities and objectives that will be apparent when performing a general and detailed description of the present invention supported in, the illustrated modalities.

### BRIEF DESCRIPTION OF THE INVENTION

In general, the bed lifting system consists of a frame that makes contact below with the boxspring or lower platform on the bed mattress. Said frame connects with at least one set of lifting legs together by at least one tubular tensioner, forming a single element in the form of “H”, said straight legs in the form of “H” are pivoting and kept together by bolts by One of its ends to the front internal part of the frame, said legs in the form of “H” at, its opposite end make direct contact with the floor without intervention of a lower tubular frame, including said lifting legs can be partially straight or can be curved In its entirety, likewise, the bed elevation system has at least one set of lifting legs in the form of “H”, which have holes at their lower ends for the incorporation of pivoting lifting legs by bolts.

Said pairs of lifting legs that form a single element in the form of “H” are joined together about half of the lifting leg by equalizing arms together by means of bolts, forming a parallelogram about half of the lifting legs and forcing to which the rotation that makes a pair of lifting legs does the other in the same way, making the frame always maintained horizontally during movement of displacement and elevation, derived from the rotating movement of the pairs of lifting legs.

In the central front portion of the frame a pair of force regulating arms, each force regulating arm has end-to-end, a series of holes, to each force regulating arm is united Through the holes and by means of binding terminals to an elastic medium, which at its opposite end is attached and unites by means of an elastic media clamping bolt o said frame in its middle portion, including said elastic media fastening bolts They serve as support and axis at the elastic means.

Each force regulating arm has at its opposite end a tensor truster means that is connected to the flexible tensioner, which is responsible for transmitting the force regulated to the semi-pulley pose previously passing by a dowling pulley.

Depending on which force regulating arm hole, the elastic medium is set by means of its binding terminal, the force that said elastic means delivers the flexible tensioner, which is attached by a flexible tensor bolt and through of a semi-heavy pulley to a force transmission arm, which in turn and by a rotation bolt, of the lifting mechanism has the ability to function as a lever and transmit the necessary strength to the frame, separating the rotation point from the frame To raise the bed.

The lifting mechanism consists of a force transmission arm, which at one end has at least one roller, tire or sprayer inserts into an adjustable lane that functions as a bearing guide, and that at its point opposite the roller or tire counts With a series of holes to spin the flexible tensioner, they serve to engulgar by said flexible tensioner bolt, one end of the flexible tensioner; and that this strength transmission arm also has this portion, with other holes to regulate the semi-pulley, which are useful for fixing and regulating the tilt of the semi-pulley snail, by means of a semi adjustment bolt Snail pulley.

In the middle part of said force transmission arm there is a rotation hole through which the rotation bolt of the lifting mechanism that also passes through the semi-pulley and the hollow tube that unites them and that in turn said bolt It also passes through a hole of the extension of the lifting leg, being able to be a welding bolt or other joining means that allows it to rotate on that axis.

By the singing or slot of said Snail Pulley passes said flexible tensioner, which transrrnts the strength graduated by said force regulatory arms to the semi-pulley and which in turn transmits the ability to generate work to the transmission arm of Force and this to the frame through the adjustable lane, with this with this a harmonious movement of graduable displacement, either lifting or vice versa of the frame, which supports the base of the bed.

Once the bed is used, the user activates the bolt (using lever, cable, solenoid of batteries, etc.) releasing the frame of the lifting legs in the form of “H”, in that way the elastic means release the accumulated energy when lowering The bed of its work position to its rest posit on.

Once the making of the bed is done, the user applying a bit of additional force when pushing it down and forward, accumulating with this energy in the elastic media and maintaining the rest position when the bolt located in the central part of the frame is crogged with the latch located on the legs in the form of “H”.

When the bed is down in the rest position, the frame is held on the floor by resting supports that are an integral part of the lifting legs. which allow that

The frame is at rest without intervention of the lifting system and once the lifting mechanism is operated, it is carried out properly without said rest supports interfere with its correct operation.

The frame has tubular extensions in the form of superimposed angle and holding by screws to the previous and posterior profiles of the frame, which allow to adapt in size said frame to suit larger bed models.

In the preferred embodiment of the invention, the frame has guides and supports for at least a set of force regulatory arms, which are useful for properly carrying out a harmonious movement of displacement either lifting or vice versa of the frame, which supports The base of the bed.

In another of the modalities of the invention, the bed lifting system characterized by having a tubular frame and also consists of at least one pair of lifting straight legs in the form of “H” pivoting to the frame, said legs in the form of “H” by its opposite end contact direct contact with no intervention of a lower tubular frame, including such lifting legs can be partially straight or can be curved in its entirety, it also has a latch arranged in the frame to hold the latch Located in the tubular tensioner joining the lifting legs to keep the lifting system for beds in its rest position, and that also said frame has tubular extensions in the form of superimposed angle and holding by screws to the preceded and posterior preflights of the frame, it also has a lifting system that rotates on a rotating bolt that crosses the extension of the lifting leg in “H” form, the strength transmission arm and the semi-pulley Snail and the hollow tube that unites them and which also consists of at least one linear elastic means that is arranged and crimped at one end to the frame of said bed lifting system and in its Another end is attached to at least one force regulating arm with pivoting holes to the frame of said bed lifting system.

A plate with holes which has a first hole to be mounted and fixed by bolts in the front portion of at least one equalizer arm, a second hole of the plate with holes is used to hold the structure in elevated form; For the above, a clamping bolt is inserted through a second hole of said orifice plate and the front lifting leg, such that the bed lifting system is held firm in its work position.

Said force regulating arm with pivoting holes to the frame counts at its opposite end, a fastening means for the flexible tensioner that transmits the force regulated to the semi-pulley and in turn to the strength transmission arm and it at least to an adjustable lane and consequently to the frame. Said force regulating arm with pivoting holes has at least one hole for said elastic medium. Being able to have more than one elastic half. Depending on what orifice, the elastic means of said force regulating arm with pivoting holes is regulated, the force that delivers the elastic means to the semi-pulley snail through the flexible tensioner.

In another of the modalities of the invention, the bed lifting system characterized by having a tubular frame and also consists of at least one pair of straight legs in the form of pivoting “H” pivoting to the frame and said legs in the form of “H” By its opposite end contact direct contact with the floor without intervention of a lower tubular frame, including said lifting legs can be partially straight or can be curved in its entirety, and which also has a bolt arranged in the frame to hold the Latch located in the tubular tensioner joining the lifting legs to keep the bed lifting system in its rest position, and that there was also said frame with tubular extensions in the form of overlapping angle and holding by screws to the previous and rear profiles of the Frame, it also has a lifting system that rotates on a rotation bolt that crosses the extension of the lifting leg in “H” form, the strength transmission arm and which also consists of at least one linear elastic means that is arranged and crimped at one end to the frame of said bed lifting system and at, its other end it is attached to a force regulating arm with pivoting holes to the rack of said bed lifting system, further a semi-powered semi-pulley that Turn together.

By the singing of said semi-pulley Snail is held and passes a flexible tensioner that transmits the force regulated to the strength transmission arm through a lever that is linked and that acts in a whole strength transmitter arm and is at least A lane adjustable and consequently to the frame.

Said force-regulating arm with pivoting holes has more than one link hole for said elastic medium. Depending on what orifice, the elastic medium of said force regulating arm with pivoting holes is regulated, the force that delivers the elastic means to the semi-pulley snail and through the flexible tensioner to the lever attached to the force transmission arm.

In another of the modalities of the invention, the bed lifting system characterized by having a tubular frame and also consists of at least one pair of straight legs in the form of “H” pivoting pivoting to the frame, said legs in the form of “H” By its opposite end contact direct contact with the floor without intervention of a lower tubular frame, including said lifting legs can be partially straight or can be curved in its entirety, and which also has a bolt arranged in the frame to hold the Locate located in the tubular tensioner joining the lifting legs to keep the bed lifting system in its rest position, and that also said frame has tubular extensions in the form of overlapping angle and holding by screws to the previous and rear profiles of the Frame, it also has a lifting system consisting of at least one elastic means that accumulates energy by torque. Said elastic medium is located in the shaft or rotation bolt that passes through the hole of the extension of the lifting legs in the form of “H” that binds the strength arm and the lifting legs located to the center of the frame.

One of its ends of said twisting elastic medium grabs the strength transmission arm and at the opposite end of said torque elastic medium is based on mid-ripped lift leg to it, thereby generating an adjustable point of support depending on the weight to move.

Said adjustment means consists of a support point or clamp that holds a small bar that makes contact between the elastic medium and the lifting leg, said bar or solid element is an integral part of the adjustment mechanism that allows to increase or decrease the arm Lever of one of the ends of the elastic torsion medium and thus increase or decrease the force that delivers said elastic means to the strength transmission arm and is to the frame.

In another of its preferred embodiments, the bed elevation system characterized by having a tubular frame and also consists of at least one pair of straight legs in the form of “H” pivoting pivoting to the frame, said legs in the form of “H” By its opposite end they contact direct contact with the floor without intervention of a lower tubular frame, including said lifting legs can be partially curved or can be curved in their entirety, and which also has a bolt arranged in the frame to hold the localized latch In the tubular tensioner joining the lifting legs to keep the bed lifting system in its rest position, and that also said frame has tubular extensions in the form of overlapping angle and holding by screws to the previous and posterior profiles of the rack. Having as a driving system, two torque elastic means located in the unions of the lifting legs and the equalizer arm, in addition to being able to be Located at the support points of the lifting legs with the frame. By achieving enough resistance to carry the stage with the bed at the elevated or work position. Said torque elastic means have a variable or means of adjustment point consisting of a support point or clamp that holds a small bar that makes contact between one end of the elastic medium and the lifting leg, said bar or solid element is an integral part From the adjustment mechanism that allows to increase or decrease the lever arm of one of the ends of the elastic torque and thereby increase or decrease the force that delivers said elastic medium to the lifting legs and east to the frame. In addition, the drive system has a linear elastic medium that supplements the force needed to achieve harmonic movement of displacement either lifting or vice versa of the frame, which supports the base of the bed.

To better understand the characteristics of the invention, the present disclosure is accompanied as an integral part of it, of the drawings that with a more non-limiting illustrative character, are described below, corresponding to the preferred embodiment of the invention.

### BRIEF DESCRIPTION OF THE FIGURES

FIG. 1 shows a top perspective view of the bed lifting system, in its working position.

FIG. 2 shows a detail view of the lifting mechanism of the bed lifting system,

FIG. 3 shows a top perspective view of the bed lifting system, in its rest position.

FIG. 4 shows another top perspective view of the bed lifting system, its rest position.

FIG. 5 shows a top perspective view of the bed lifting system in its working position with its folded and deployed extensions.

FIG. 6 shows a detail view of the force transmission arm, semi-pulley snail, fastening bolt and the hollow tube that connects them to be an integral part of the lifting mechanism of the bed lifting system.

FIG. 7 shows a side view of another modality of the bed lifting system, in its rest position.

FIG. 8 shows a side view of the above mode of the bed lifting system, in its working position.

FIG. 9 A lateral view of another modality of the bed lifting system in its rest position.

FIG. 13 shows a side view of the b e mode of the bed lifting system in its working position.

FIG. 11 A side view of another modality of the bed lifting system in its rest position.

FIG. 12 shows a side view of the above mode of the bed lifting system in its working position.

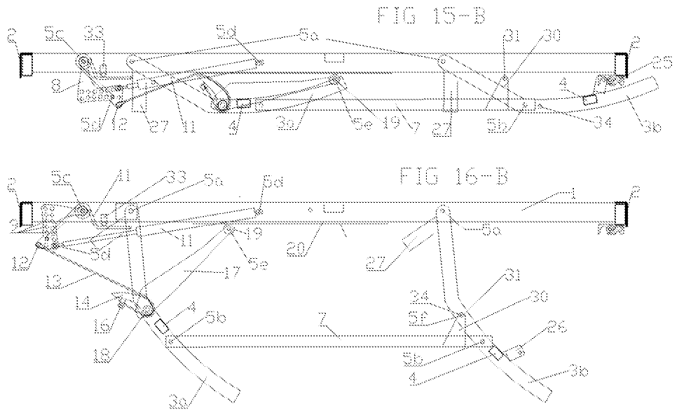

FIGS. 13A, 13B and 13C illustrate lateral views of another of the modalities of the bed lifting system in their rest position, where different fixing locations of the linear elastic media are exhibited.

FIGS. 14A, 14B and 14C show side views of the above mode shown in FIGS. 13a up to 13c, of the bed lifting system in their working position, where different fixing locations of linear elastic media are exhibited.

FIG. 15 A side view of another modality of the bed lifting system in its rest position.

FIG. 15 at a side view of another modality of the bed lifting system in its rest position.

FIG. 15-B a side view of another embodiment of the bed ting system in its rest position.

FIG. 16 shows a side view of the previous mode of the bed lifting system in its working position.

FIG. 16-A shows a side view of the above mode of the bed lifting system in its work position.

FIG. 16-B shows a side view of the above mode of the bed lifting system in its working position.

For a better understanding of the invention, it will be made to make the detailed description of any of the modalities, shown in the drawings that for more non-limiting illustrative purposes are annexed to the present description.

### DETAILED DESCRIPTION OF THE INVENTION

The characteristic details of the bed lifting system are clearly shown in the following description and in the illustrative drawings that are annexed, using the same reference signs to indicate the same parts of the invention.

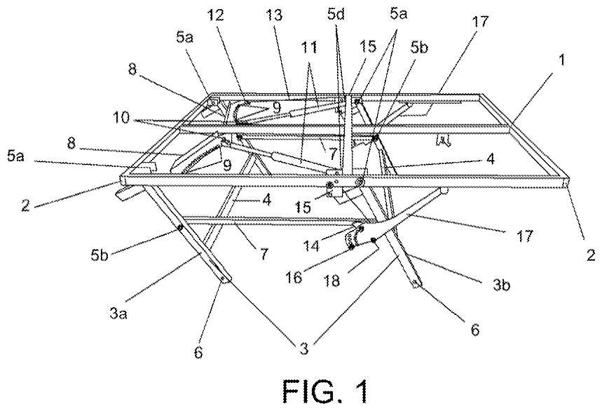

Referring to FIGS. 1 to 5 that presents a top perspective view of the bed lifting system in its work position, where a frame (1) is shown (1) that makes contact below with the Boxspring or lower pitch on mattress The bed, said frame counts tubular extensions in the form of angle (2) overlapping and holding by fixing means to the prior and rear profiles of the frame which allow to adapt in size said frame (1) to suit as well as models of dimensional beds bigger.

Said frame (1) connects with a set of lifting legs (3) joined together by at least one tubular tensioner (4), thus forming a single element in the form of “H”, said legs in the form of “H” are pivoting and they are kept together by clamping bolts (5a) at one end to the frame (1) and at its opposite end resting directly on the floor without frame intervention or any structure; Likewise, each set of lifting legs (3) in the form of “H”, have holes at their lower ends for the incorporation of pivoting lifting legs (6) and by means of fixing means. Said pairs of lifting legs (3) that form a single element in the form of “H” are joined together at half length of the leg by equalizing arms (7) by means of fastening bolts (5b) and forming a nearly parallelogram In the middle of the lifting legs (3) and forcing the rotation to make a pair of lifting legs (3) the other in the same way, achieving that the frame (1) is always maintained in horizontal position during movement of displacement and elevation, derived from the rotating movement of the pairs of lifting legs (3).

In the front portion of the frame (1) they are linked by means of clamping bolts (5c) to said frame (1), a pair of force regulating arms (8), each force regulating arm (8) has end A serum a series of pivotal force regulating arm holes (9) to said frame (1), at each force regulating arm (8) is attached to the force regulating arm holes (9) by joining terminals (10) At an elastic medium (11), which at its opposite end is held and unites by means of a clamping bolt (5d) of elastic medium to said frame (1) in its central portion and by said binding terminal (10) Said elastic means (11) is attached to at least one force-regulating arm hole (9) of said force regulating arm (8), including said medium fastening bolts (5d) Elastic media serve as support and axis at elastic means (11).

Each force regulating arm (8) has a tensor crimping means (12) which is connected to the flexible tensioner (13), which is responsible for transmitting the force regulated to the semi-pulley (14) previously passing by A diverting pulley (15).

Depending on what hole (9) of force regulatory arm (8), the elastic medium (11) is set, by means of its binding terminal (10) increases or decreases the force that said elastic means (11) deliver to the flexible tensioner (13), which is joined by a flexible tensioner bolt (16) to a force transmission arm (17), which in turn and by a rotation bolt (18) of the lifting mechanism has the Ability to function as a lever and transmit the necessary force to the frame (1) to raise the bed.

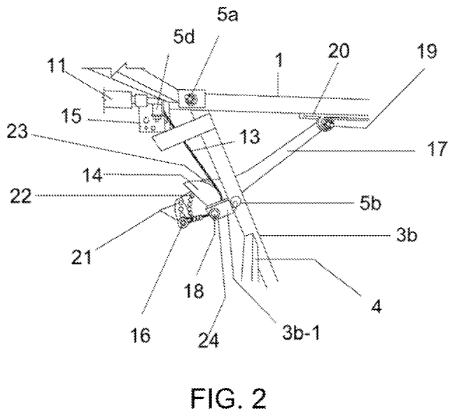

Referring to FIG. 2 that has a detail view of the lifting mechanism of the bed lifting system where the lifting mechanism for the bed lifting system is attached to an extension (3B-1) of the lifting legs (3b) by means of the rotation bolt (18) where the lifting mechanism is shown, which consists of a force transmission arm (17) that at one end has at least one roller, rim (19) or lozade inserted in An adjustable rail (20) that functions as a bearing guide, and that at its point opposite the roller or rim (19) has at least one hole to crout to the flexible tensioner (21) and serve to crouting by said joint bolt of the flexible tensioner (16) at one end of the flexible tensioner (13); and that said strength transmission arm (17) also has this portion, with other holes (22), to regulate the semi-pulley of snail which are useful for fixing and regulating the tilt of the semi-pulley snail (14), by means of a semi-pulley snail adjustment bolt (23); In the central middle part of said force transmission arm (17) there is a rotation hole (24) that also crosses the hollow tube (36) the semi-pulley (14) and by which a rotation bolt is passed (18) From the lifting mechanism, and turning in: turn by the extension of lifting legs (3B-1) and can be a bolt subject with some joining medium that allows it to rotate on that axis.

By the singing or slot of said semi-pulley Snail (14) passes said flexible tension (13) that transmits the force graduated by said force regulatory arms (8) to the semi-pulley (14) and which in turn is transmitted to the strength transmission arm (17) and this to the frame (1) through the adjustable lane (20) the ability to generate work, achieving a harmonious movement of graduable displacement either lifting or vice versa of the frame, which supports The base of the bed.

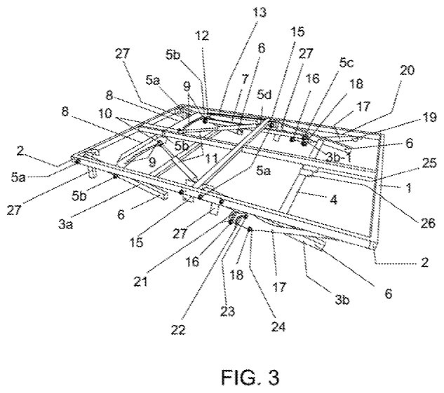

Referring to FIG. 3, which presents a top perspective view of the bed lifting system in its rest position, where the bed has been used, the user drives the bolt (25) freeing the frame (1) of the Lifting legs (3) in the form of “H”, in this way the elastic means (11) release the energy accumulated when lowering the bed of their work position to their rest position.

Once the bed is stretched the user down applying a little additional force when pushing it down and forth, accumulating in this way energy in the elastic media (11) and maintaining the rest position when the bolt (25) crimps with the latch (26) located on the lifting legs (3B).

When the bed is down in the rest position, the frame (1) is held on the floor by resting supports (27), which allow the frame (1) to rest on the surface without force intervention Of the elastic means (11), and once the lifting mechanism is operated, it is carried out properly without said rest supports (27) interfere with its correct operation.

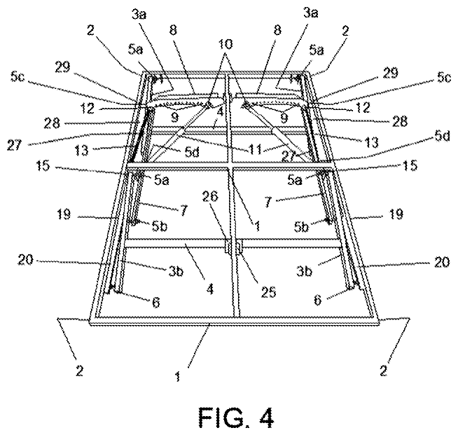

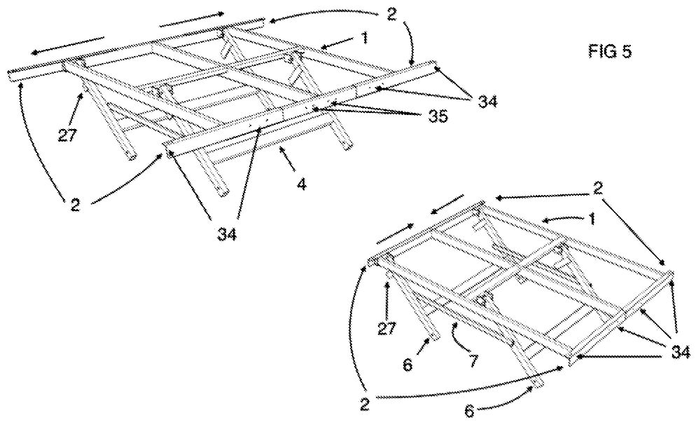

Referring to FIG. 4, which has a top perspective view of the bed lifting system in its rest position, where a frame (1) is shown, it comprises at least one pair of lifting legs (3) in the form of “H” pivoting pivoting (1) and that by its opposite end contact direct contact with the floor, and which also has a bolt (25) disposed in said frame (1) To hold the latch (26) located on the tubular tension (4) that connects the lifting legs (3) to maintain the lifting system for beds in its rest position, and that also said frame (1) has tubular extensions in the form of angle (2) superimposed and hold by screws to the anterior and posterior profiles of the frame; Said frame (1), also has guides (28) and supports for guides (29) of at least one for force regulating arm (8), which are useful for properly carrying out the harmonic movement of displacement either lifting or vice versa of the frame (1), which supports the base of the bed.

Referring to FIG. 5 that has two top perspective views of the bed lifting system in its work position, one with the extensions (2) deployed and another view with the folded extensions (2), where it is shown A frame (1) that makes contact below with the Boxspring or lower pass to the bed mattress, said rack counts tubular extensions in the form of angle (2) overlapping and holding by screws to the previous and posterior profiles of the frame which allow Adapt in size said frame (1) To suit themselves to larger dimensional bed models, said tubular extensions in the form of angle (2) have holes (34) to hold the Box Spring or lower deck on the bed mattress. In addition to holding on the previous and posterior profiles of the frame (1).

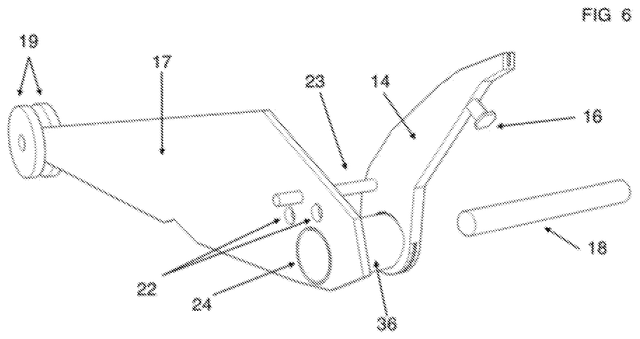

Referring to FIGS. 6, which presents a perspective view of the strength transmitting arm (17) with its tires (19), and its adjusting holes for semi-pulley snail (22), its adjustment bolt (23) of position of Semi Pulley Snail; semi-pulley (14) with its elastic means (16) for elastic medium (13), rotation bolt (18) from the extension of the lifting leg that crosses the hollow tube (36) and that it connects the arm of Strength transmission (17) and the Semi Pulley Snail (14).

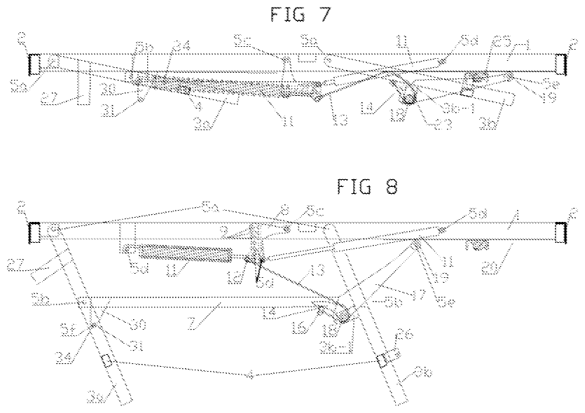

Referring to FIGS. 7 and 8, which have side views of another embodiment of the bed lifting system, in its rest and work position respectively, where a tubular frame (1) comprising at least one pair of lifting legs (3A and 3B) in the form of “H” pivoting to the frame (1) and that by its opposite end contact direct contact with the floor, and which also has a bolt (25) disposed in the frame (1) for Hold the latch (26) located on the tubular tension (4) that connects the lifting legs (3) to maintain the bed lifting system in its rest position, and that also said frame (1) has tubular extensions in shape of angle (2) overlapped and hold by screws to the anterior and posterior profiles of the frame; It also has a lifting system that rotates on a rotation bolt (18) that crosses the extension of the lifting leg (3B) in “H” form, the force transmission arm (17) and the semi-pulley (14) and which also consists of at least one linear elastic (11) medium that is arranged and crimped by fastening bolts (5d) at one end to the frame (1) of said bed lifting system and in its other End is fastened by connecting terminals (10) or fixing means to the force regulating arm (8) through at least one hole in the force regulating arm (9) to the frame (1) of said bed lifting system.

Said force-regulating arm (8) with force regulating arm holes (9) has at its opposite end with a flexible tensioner crimping means (12) which through the flexible tensioner transmits the force regulated to the semi Snail pulley (14) and in turn to the force transmission arm (17) and this at least one adjustable lane (20) and consequently to the frame (1). Said force regulating arm (8) with pivoting holes has at least one link hole for said elastic medium (11), could more than one elastic medium (11). Depending on what force regulating arm hole (9), the elastic media (11) is regulated, the force that delivers the elastic means (11) to the semi-pulley Snail (14) through the flexible tensioner (13).

A plate with holes (30) to be fixed by means of welding or bolts at one end of at least one equalizer arm (7), the hole (31) of the plate with holes (30) serves to hold the structure in elevated form; For the above, a clamping bolt (5F) is inserted through the orifice of said orifice plate (30) and the hole (34) the lift leg (3A), so that the bed lifting system is held and sign in their work position.

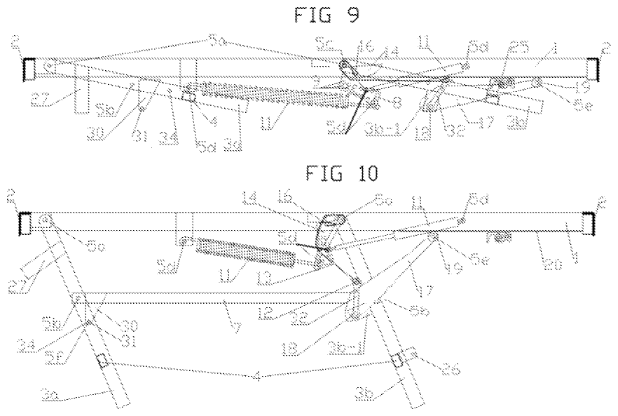

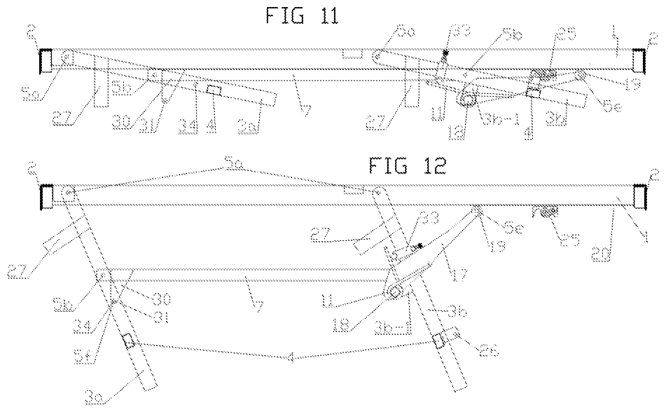

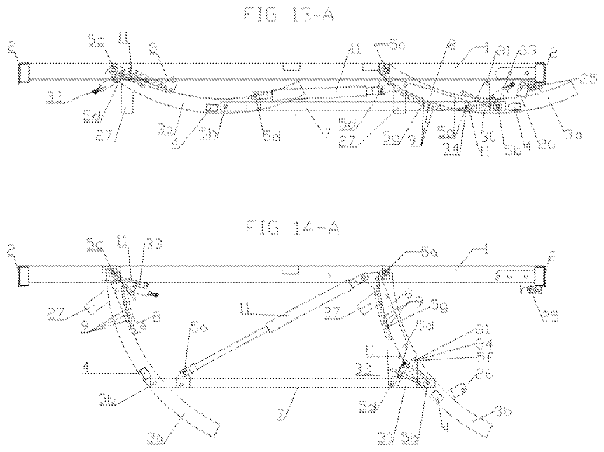

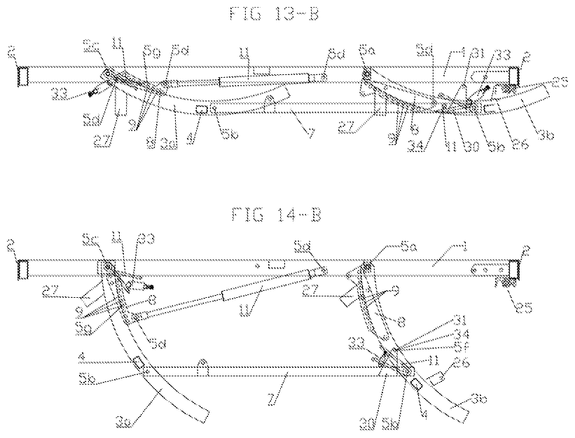

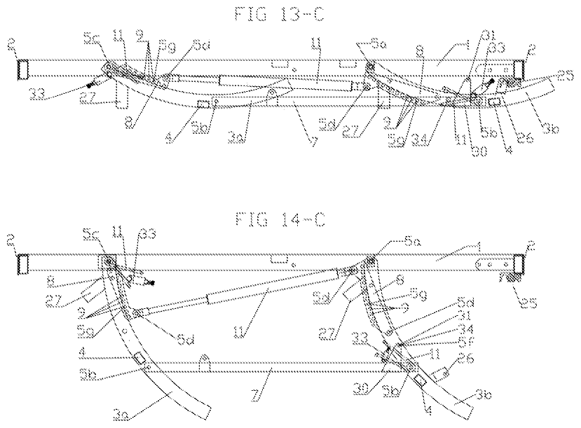

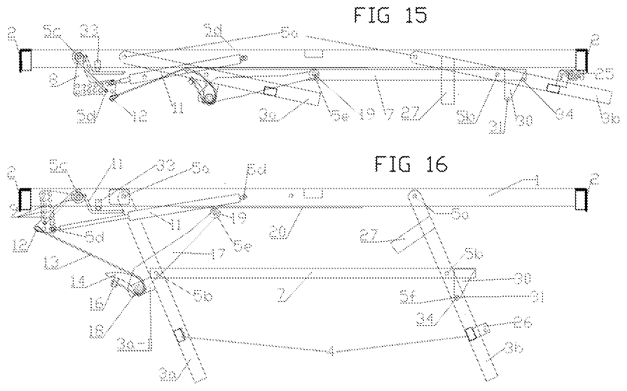

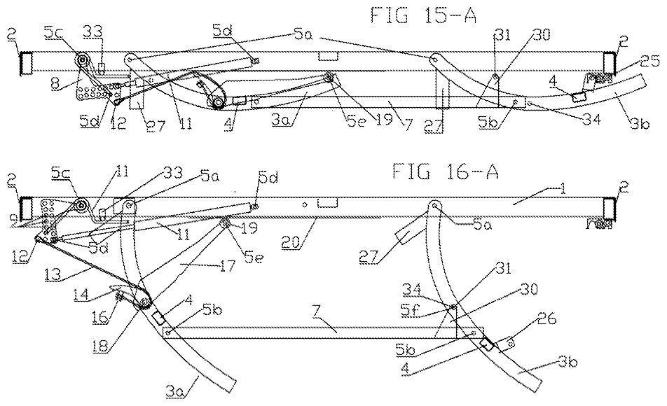

Referring to FIGS. 9 and 10, which have side view of another modality of the bed lifting system, in its rest and work position respectively, where a tubular frame (1) comprising at least one pair of lifting legs (3A and 3B) in the form of “H” pivoting to the frame (1) and that by its opposite end they make direct contact with the floor, and that it also has a bolt (25) disposed in the frame (1) To hold the latch (26) located on the tubular tensioner (4) that connects the lifting legs (3) to keep the bed lifting system in its rest position, and that also said frame (1) has tubular extensions in Angle form (2) superimposed and attached by screws to the anterior and posterior profiles of the rack, also has a lifting system rotating on a rotation bolt (18) that crosses the extension of the lifting leg (3) in shape “H”, the strength transmission arm (17) and the semi-semi-pulley (14) and which also consists of at least one linear elastic (11) means that is arranged and engaged at one end to the frame (1) of said bed lifting system and in its another end is held at least to a force regulating a (8) of said bed lifting. system, further than that force regulator arm (8) is held a semi-pulley (14) which rotates as a whole, by the singing scale semi pulley (14) is held and passes a flexible tensioner (13) that transmits the force regulated to the force transmission arm (17) through a rotation lever (32) that is united and that Acts together with the force transmitter arm (17) and this with at least one adjustable lane (20) and consequently to the frame (1) of said bed lifting system.

Said force regulating arm (8) has more than one pivoting force regulatory arm hole (9) for said elastic medium (11). Depending on what orifice, the binding terminal (10) or a clamping bolt (5d) of elastic medium (11) is crimped to said force regulating arm (8) with pivoting holes is regulated by the strength that deliver the elastic means (11) to the semi-pulley (14) through the flexible tensioner (13). A plate with holes (30) to be fixed by means of welding or bolts at one end of at least one equalizer arm (7), the hole (31) of the plate with holes (30) serves to hold the structure in elevated form; For the above, a clamping bolt (5F) is inserted through the orifice of said orifice plate (30) and the hole (34) the lift leg (3A), so that the bed lifting system is held and sign in their work position.

Referring to FIGS. 11 and 12, which have side views of another modality of the bed lifting system, in its rest position and work respectively, where a tubular frame (1) is shown, which comprises at least one Pair of lifting legs (3A and 3B) in the form of “H” pivoting pivoting (1) and that by its opposite end contact direct contact with the floor, and that it also has a bolt (25) arranged in the frame (1) To hold the latch (26) located in the tubular tensioner (4) that connects the lifting legs (3) to keep the bed lifting system in its rest position, and that also said frame (1) has tubular extensions In the form of angle (2) overlapping and holding by screws to the anterior and posterior profiles of the frame, it also has a lifting system consisting of at least one elastic means (11) that accumulates energy by torque. Said elastic means (11) is located in the shaft or rotation bolt (18) that passes through the hole of the extension (3B-1) of the lifting legs (3B) that binds the strength transmission arm (17) and the lifting legs (3B) Located to the center of the frame (1).

One of its ends of said torque elastic (11) grabs to the force transmission arm (17) and at the opposite end of said torque elastic (11) is based on the mid-length leg (3B) tied to the Frame (1) generating an adjustable support point depending on the weight to be moved.

Said force adjustment means (33) consists of a point of support or clamp that holds a small bar that makes contact between the elastic means (11) and the lift leg (38), said bar or solid element is an integral part the adjustment mechanism that allows to increase or decrease the lever arm of one of the ends of the torque elastic (11) and thereby increase or decrease the force that delivers said elastic medium (11) to the strength transmission arm (17 and this to the frame (1). A plate with holes (30) to be fixed by means of welding or bolts at one end of at least one equalizer arm (7), the hole (31) of the plate with holes (30) serves to hold the structure in elevated form; For the above, a clamping bolt (5F) is inserted through the orifice of said orifice plate (30) and the hole (34) the lift leg (3A), so that the bed lifting system is held and sign in their work position.

Referring to FIGS. 13A-130 and 14A-140, which have side views of another embodiment of the bed lifting system, in its rest position and work, where a tubular frame (1) is shown, which comprises at least one pair of lifting legs (3A and 3B) in the form of “H” pivoting pivoting (1) and that by its opposite end contact direct contact with the floor, and which also has a bolt (25) arranged in the Frame (1) To hold the latch (26) located on the tubular tension (4) that connects the lifting legs (38) to maintain the lifting system for beds in its rest position, and that also said frame (1) account with tubular extensions in the form of angle (2) superimposed and hold with fixing means to the previous and rear profiles of the frame (1). Having as a motor system, linear elastic means (11) which are fixed at one end the equalizer arm (7) and by its opposite end is attached to the force regulating arm (8) which has adjusting bolt (5g) and holes to graduate force, located pivoting on the lifting legs (3b) or the equalizer arm (7). FIG. 13A shows lifting system for beds in its rest position and in FIG. 14A the same lifting system for beds is shown in its working position.

In FIGS. 13B and 148 said linear elastic means (11) are fixed at one end to the frame (1) and at its end opposite to the force regulator arm (8) which has adjustment bolt (5g) and holes (9) to graduate force, located pivoting on the lifting legs (3A).

in FIGS. 13C and 14C said linear elastic means (11) are fixed to the force regulating arm (8) which has adjustment bolt (5g) and holes (9) to graduate force, located pivoting to the lifting leg (3b) And on its other end, to the other force regulating arm (8) featuring adjustment bolt (5g) and holes (9) to graduate force, located pivotane in the lift leg (3a).

The drive system has torsion elastic (11) means located in the joints as already described and illustrated in FIGS. 13A-14C of the lifting legs (3A and 3B) and the Equalizer Arm (7); In addition to being located at the support points of the lifting legs (3A. 38) with the frame (1). By achieving enough resistance to carry the platform with the bed at the elevated or work position. Said torque elastic (11) means have a variable or medium force adjustment point (33) consisting of a support point or clamp that holds a small bar that makes contact between one end of the elastic medium (11) and Its support point, being able to be any of its lifting legs (3A) or (3B), or the equalizer arm (7), or the frame (1), said bar is part Integral of the force adjustment means (33) that allows to increase or decrease the lever arm of one of the ends of the torque elastic (11) and thereby increase or decrease the force that delivers elastic means (11) to the frame (1). A plate with holes (30) to be fixed by means of welding or bolts at one end of at least one equalizer arm (7) the hole (31) of the plate with holes (30) serves to hold the structure in elevated form; For the above, a fastening bolt (5F) is inserted through the orifice of said orifice plate (30) and of the hole (34) of the lifting leg (3A), so that the bed lifting system is maintained Subject and firm in your work position.

Referring to FIGS. 15 and 16, which have lateral views of another embodiment of the bed lifting system, in its rest position and work respectively, where a tubular frame (1) is shown, which comprises at least one Pair of lifting legs (3A and 3B) in the form of “H” pivoting pivoting (1) and also has a bolt (25) disposed in the frame (1) to hold the latch (26) located in the tubular tensioner (4) joining the lifting legs (3) to keep the bed lifting system in its rest position, and that also said frame (1) has tubular extensions in the form of angle (2) superimposed and subject by screws to the anterior and posterior profiles of the frame, also has a lifting system consisting of at least one linear elastic medium (11) that is attached from the frame (1) and link to one of the holes in the force regulating arm (9) and also with at least one elastic medium (11) that accumulates energy through torsion. Said torque elastic medium (11) is located in the shaft or rotation bolt (5c) that holds the force regulating arm (8) which is attached to the frame (1), also has a force transmitting arm (17) that passes through the hole of the extension (3A-1) of the lifting legs (3A) that connects the force transmission arm (17) and the lifting legs (3A) located at the forefront of the frame (1).

A plate with holes (30) to be fixed by means of welding or bolts at one end of at least one equalizer arm (7), the hole (31) of the plate with holes (30) serves to hold the structure in elevated form; For the above, a clamping bolt (5F) is inserted through the orifice of said orifice plate (30) and the hole (34) the lifting leg (3B), such that the bed lifting system is held and sign in their work position.

Referring to FIGS. 15-A and 16-A shows a modality of the present invention (see FIGS. 15 and 16) with the lifting legs (3A and 3B) curves in the form of “H”, it facilitates the lifting since the Being supported to the soil about half said curved legs decrease the initial lever radius with it, the start of the elevation is facilitated since it varies the distance of the support against the floor and in this way a lower effort of the elastic means is required (11). Said lifting legs (3A and 3b) curves that by its opposite end of the frame (1) make direct contact with the floor, may be included in any of the modes of the lifting system for beds described above.

Referring to FIGS. 15-B and 16-B shows FIGS. 15 and 16 with partially curved (3A and 3B) legs in the form of “H”, which facilitates the lifting since being supported to the soil close to Half said partially curved lifting legs (3A and 3B) facilitates the start of the elevation as it varies the distance of the support against the floor and in this way a lower effort of the elastic means (11) is required. Said partially curved lifting legs (3A and 3B) that by its opposite end of the frame (1) contact direct contact with the floor, may be included in any of the modes of the lifting system for beds described above.

The invention has been sufficiently described so that a person with average knowledge in the matter can reproduce and obtain the results mentioned in the present invention. However, any person skilled in the field of the technique that the present invention may be able to make modifications not described in the present application, however, if for the application of these modifications in a given structure or in the manufacturing process of the same, the subject claimed in the following claims is required, said structures shall be comprised within the scope of the invention.

1. A raising system for beds of the structure type that is put under the bed, with the intention of lifting and separating the bed from the wall and night tables, to a raised position to make the bed without crouching over the bed, or be in bad position and make accessible the space beneath than said bed, characterized in that it consists of a tubular frame with at least one pair of lifting legs in the form of pivoting to the frame at one end of them, and by the opposite end make direct contact with the floor without intervention of another tubular frame or structure, and that it also has a bolt arranged in the frame to hold the latch located in a tubular tensioner that unites the lifting legs to keep the lifting system for beds in rest position, and that also said frame has tubular extensions in the form of overlapping angle and holding by means of fixation to the previous and posterior profiles of the frame, and that also has with a lifting system that rotates on a rotation bolt that crosses the extension of the lifting leg in “H” form, a strength transmission arm, a semi-pulley snail and a hollow tube that unites them, and which also consists of at least one elastic means that is arranged and crimped at one end to the frame of said bed lifting system and at its other end it is attached to a pivoting force regulating arm with holes to the frame of said lifting system For beds.

2. The bed lifting system in its rest position according to claim 1, characterized in that said “H” lifting legs that support said frame are substantially straight.

3. The bed lifting system in its rest position according to claim 1, characterized in that said lifting legs in the form of “H” that support said frame, they are substantially curved, which are linked pivoting to the frame and They rest near their middle part to the floor, and gradually by turning said substantially curved legs allow the turning radius to be gradually increasing until they reach their working position and decrease the radius of rotation in the opposite direction.

4. The lifting system for beds in its resting position according to claims 1, 2 and 3, characterized in that said frame with at least one set of lifting legs in the form of “H”, which are pivoting and are joined together by equalizing arms, forming a parallelogram next to the Half of the lifting legs and forcing the turn to make a pair of lifting legs does the other in the same way, achieving that the frame is always maintained horizontally during the movement of displacement, derived from the rotating movement of the pairs of Lifting legs.

5. The lifting system for beds in its resting position according to the preceding claims, characterized in that said frame lifting system has at least one force regulating arm, which is link to between its extremes to at least one elastic means and by one of its ends is held and pivotably connected to said frame; At least one force-regulating arm is connected to the opposite end with at least one flexible tensioner, which is responsible for transmitting the force regulated at least one semi-pulley and at least one force transmission arm, previously passing by at least one diverting pulley and said at least one strength transmission arm at the other end has at least one roller or tire or slick inserts into an adjustable lane that functions as a bearing guide.

6. The lifting system for beds in its rest position according to claim 5, characterized in that said elevation system further comprises at least one strength transmission arm at its opposite end or greater than the rotation point to the roller or tire or slick has a series of holes that serve to link by means of a joining medium or one end of the flexible tensioner, said force transmission arm also has in this portion with other useful holes for fixing by means of a joint or bolt of adjustment in position and regulate the tilt of the semi-pulley snail with respect to the force transmitting arm, forcing them to rotate evenly, also near the middle or end of said at least one force transmission arm there is a rotation hallow shaft that It also crosses the semi-pulley and the hollow tube that unites them and through which a rotation bolt passes, which in turn goes through a hole in the extension of at least one a lift leg, being able to be a bolt attached as a means of joining that allows it to rotate on this axis and function as a lever to said at least one strength transmission arm to transmit the necessary force to raise the bed.

7. The lifting system for beds in its resting position according to claim 5, characterized in that said at least one force regulating arm has a series of holes or support points or preferably end-to-end and depending on What force-regulating arm hole setting the elastic media by its binding terminal, increases or decreases the force that said elastic means deliver to the flexible tensioner which is attached by a direct bolt to the semi-pulley snail that rotates uniform to a strength transmission arm; Elastic media clamping. bolts serve as support and axis at the elastic means.

8. The lifting system for beds in its resting position according to the preceding claims, characterized in that said semi-pulley snail is attached to the strength transmission arm by a hollow tube and that by the edge or slot of said semi-pulley snail passes said flexible tensioner, which transmits the graduated force by said force regulatory arms to the variable radio snail semi-pulley and which in turn is transmitted the ability to generate strength transmission arm, to the rim and this frame through the adjustable lane, achieving with this a harmonious movement of adjustable displacement, either lifting or vice versa of the frame, which supports the base of the bed.

9. The lifting system for beds in its resting position according to the preceding claims, characterized in that said semi pulley of variable radio is linked by a hollow tube to the force regulating arm and subjects pivotantly to the frame and that by the singing or slot of said semi-pulley Snail passes and said flexible tensioner, which transmits the force graduated by said force regulatory arms to the lever that is attached to the strength transmission arm and which in turn is transmitted the capacity of generate work on the strength transmission arm and this through the rim to the frame, through the adjustable rail, with this a harmonious movement of adjustable displacement, either lifting or vice versa of the frame, which supports the base of the bed

10. The lifting system for beds in its rest position according to the preceding claims characterized in that said at least one set of lifting legs are joined together by at least one tubular tensor, forming a single element in the form of “H”, Said legs in the form of “H” incorporate at least one support for rest, said legs in the form of “H” are pivoting and are kept together by bolts at one end to the front and central part, of the frame and present Holes at their lower ends for the incorporation of pivoting lifting leg extensions by bolts.

11. The lifting system for beds in its resting position according to the previous claims, characterized in that said bolt releases the frame of the lifting legs in the form of “H”, in this way the elastic means release the energy accumulated to the lower the bed of your work position to your rest position, the frame low applying a bit of additional force by pushing it down and forth, accumulating with this energy in the elastic media and keeping the resting position when the bolt is hooked The latch.

12. The bed elevation system in its resting position according to all the above claims, characterized in that in rest position, the frame is held on the floor by resting supports, which allow the frame to be at rest on the surface without the need for the elevation system and once the lifting mechanism is operated, it is carried out properly without said rest supports interfere with its correct operation.

13. The bed elevation system in its rest position according to all the preceding claims. characterized in that the frame has tubular extensions in the form of overlapping angle and holding by means of fastening to the previous and rear profiles of the frame which allow to adapt the size of said rack to be adapted as well as larger-dimensional bed models

14. The lifting system for beds in its rest position according to claim 13, characterized in that the tubular extensions in the form of overlapping angle and holding the frame can have holes by which means of clamping means to hold the Box Spring or lower bed of bed mattress.

15. The lifting system for beds in its resting position according to all the preceding claims, characterized in that the frame comprises guides and supports for at least one force regulating arm, which are useful for properly carrying out a harmonious movement of displacement Whether it is lifting or vice versa of the frame, which supports the base of the bed.

16. The lifting system for beds in its resting position according to all the preceding claims, characterized in that it has at least one plate with an orifice in at least one equalizer arm that at least one hole of at least a lift leg allows to ensure with a bolt the bed lifting system in its elevated or work position.

17. The bed elevation system in its resting position according to all the preceding claims, characterized in that it has at least one elastic torsion means that accumulates energy that is located in the shaft or rotation bolt that passes through the hole of the extension of the lifting legs that joins the strength transmission arm and the Lifting legs that may be located between the ends of the frame; One of its ends of said torsion means to the strength transmission arm and at the opposite end of said torsion elastic medium is based on middle lift leg, said torsion elastic means have a point of support variable or means of adjustment consists of a support point or clamp that holds a small bar that makes contact between one end of the elastic means and the lifting leg, said solid bar or element is an integral part of the adjustment mechanism that allows to increase or decrease the Lever arm of one of the ends of the elastic torsion means generating an adjustable support point depending on the force necessary to move the required weight.

18. The bed elevation system in its resting position according to all the preceding claims, characterized that it has at least one linear elastic means that may be subject to the selected points of: the equalizer arm and at its opposite end to the force regulator arm that has holes and adjustment bolt to graduate the force on the lift leg or the equalizer arm; the frame and by its end opposite the force regulator arm that has holes and adjustment bolt to graduate the force placed on the lift leg, or fixed by both exterms to the force regulator arms that have holes and adjustment bolt for graduate force placed on the lifting legs, allowing to regulate the strength that delivers at least said linear elastic means and can also have torsion elastic means that are located in the joints of the lifting legs and the rack and the equalizer arm and the lifting legs, thus achieving enough resistance to carry the stage with the bed at the elevated or work position; wherein said torsion elastic means have a variable or means adjustment point, it consists of a support point or clamp that holds a small bar that makes contact between one end of the elastic medium and the lift leg, and end of the elastic means and the frame, said bar or solid element is an integral part of the adjustment mechanism that allows to increase or decrease the lever arm of one of the ends of the elastic torsion means and thereby increase or decrease the torque force that delivers elastic medium to the articulation of the lifting legs and the frame and the articulation bf the lifting legs and the equalizer arm.

19. The lifting system for beds in its resting position according to a the above claims, characterized in that it has at least one linear elastic means engaged at the force regulating arm and at its other end attached to the frame and also has at least one elastic means that accumulates energy by torsion and that is located in the shaft or rotation bolt that is attached to the force regulating arm can be located between the ends of the frame; One of its ends of said twisting elastic medium grabs the force regulating arm and at the opposite end of said elastic torsion means rests on the frame, both elastic means can work altogether or supplementary to the other means; wherein said elastic torsion means has a variable or adjustment point that consists of a support point or clamp that holds a small bar that makes contact between, one end of the torsion elastic means and the frame, said bar or solid element is Integral part of the adjustment mechanism that allows to increase or decrease the lever arm of one of the ends of the elastic torsion means and thereby increase or decrease the torque that delivers said elastic medium to the force regulating arm and said force transmitted to the Flexible tensioner, to the semi pulley snail, to the strength transmission arm, to the rim and the frame through the adjustable lane.

20. The lifting system for beds in its rest position according to all the preceding claims, characterized in that the lifting system combines several types of elastic means, as well as the arrangement of said elastic means to supplement the necessary strength and achieve the harmonious movement of displacement either lifting or vice versa of the frame, which supports the base of the bed.

21. The lifting system for beds in its rest position according to all the preceding claims, characterized in that the lifting system may be crimp or set on any of the lifting legs or all at the same time, and achieve the harmonic movement of displacement Whether it is lifting or vice versa of the frame, which supports the base of the bed.
